(19) United States
(12) Patent Application Publication
(10) Pub. No.: US 2025/0044577 A1
(43) Pub. Date: Feb. 6, 2025

(54) Flex Hinge Actuator Assembly

(71) Applicant: Hutchinson Technology Incorporated, Hutchinson, MN (US)

(72) Inventor: Mark A. Miller, Hutchinson, MN (US)

(21) Appl. No.: 18/787,919

(22) Filed: Jul. 29, 2024

Related U.S. Application Data
(60) Provisional application No. 63/530,825, filed on Aug. 4, 2023.

(51) Int. Cl. G02B 26/08; G02B 7/09; G02B 27/64

(52) U.S. Cl. CPC G02B 26/0875; G02B 7/09; G02B 27/646

(57) ABSTRACT

The present embodiments relate to a flex hinge actuator. The actuator can include a base and a moving carriage configured to move in a direction (e.g., Z direction). A flex hinge assembly can include structures disposed on multiple sides (e.g., 2-sides, 4-sides). The flex hinge assembly structures can limit movement of the moving carriage in other directions than the Z direction to limit adverse motions of the moving carriage. The actuators as described herein can include a simple structure to constrain pitch and yaw tilt during Z motion of a payload. The actuator can push on sides of structure to move a carriage up and down (or in the Z-direction).

### CROSS-REFERENCE TO RELATED APPLICATIONS

This application claims the benefit of, and priority to, U.S. Provisional Application No. 63/530,825 filed on Aug. 4, 2023, which is hereby incorporated by reference in its entirety.

### FIELD

The invention relates generally to an actuator, and more particularly, to an actuator with a flex hinge assembly to limit unwanted motion of the actuator.

### BACKGROUND

An actuator can be used in a variety of contexts. For example, an actuator can move a lens back and forth to focus the lens as part of an autofocus system. In many cases, it can be desirable to move a moving component in a desired direction (e.g., a Z direction) to increase efficiency in implementing such an autofocus system.

However, many actuator designs may cause movement of the moving component in directions other than the desired direction (e.g., pitch, yaw, roll). Such adverse motions can cause stress in the actuator, such as these forces adding unwanted torque and out of plane bending forces on the actuator. Therefore, it is desirable for an actuator with a design that constrains unwanted movement (e.g., pitch, yaw, tilt) during Z-motion of a payload.

### SUMMARY

The present embodiments relate to a flex hinge actuator. The actuator can include a base and a moving carriage configured to move in a direction (e.g., Z direction). A flex hinge assembly can include structures disposed on multiple sides (e.g., 2-sides, 4-sides). The flex hinge assembly structures can limit movement of the moving carriage in other directions than the Z direction to limit adverse motions of the moving carriage. The actuators as described herein can include a simple structure to constrain pitch and yaw tilt during Z motion of a payload. The actuator can push on sides of structure to move a carriage up and down (or in the Z-direction).

In a first example embodiment, a flex hinge actuator is provided. The flex hinge actuator can include a static base and a moving carriage configured to move in a Z direction with respect to the static base. The flex hinge actuator can also include a flex hinge assembly configured to allow motion of the moving carriage in the Z direction and limit movement in other directions. The flex hinge assembly can include at least two flex hinge structures disposed on corresponding sides of the flex hinge actuator.

In some instances, the flex hinge assembly includes flex hinge structures disposed each of four sides of the flex hinge actuator.

In some instances, each flex hinge structure includes a first link and a second link. The first link can connect to the static base at a first hinge joint and to the second link at a second hinge joint. The second link can connect to the moving carriage at a third hinge joint. In some instances, any of the first, second, or third hinge joints include a flexible metal hinge.

In some instances, each flex hinge structure further includes at least one link connecting the moving carriage to the flex hinge structure and a bimorph actuator configured to push on the at least one link. The bimorph actuator can include a beam including a first end fixed to the flex hinge structure and a second end comprising a free end. Movement of the free end can be configured to push on the at least one link. In some instances, the bimorph actuator further includes a shape metal alloy (SMA) material disposed along the beam between the fixed end and the free end.

In some instances, the flex hinge structure includes at least a first flex hinge structure orientated in a first direction and a second flex hinge structure oriented in a second direction opposite that of the first direction.

In some instances, the flex hinge actuator further comprises a lens connected to the moving carriage, an outer housing, and four bimorph actuators, with each of the four bimorph actuators being disposed on the outer housing and providing X/Y motion of the moving carriage.

In some instances, the flex hinge actuator further comprises a cover disposed over a portion of the moving carriage and outer housing, the cover comprising end stops to limit movement of the moving carriage past a threshold stroke range.

In some instances, the flex hinge actuator further comprises an image sensor assembly disposed below the flex hinge assembly and a flexible sensor circuit connected to the flex hinge assembly and the image sensor assembly.

In another example embodiment, a device is provided. The device can include a static base and a moving carriage configured to move in a Z direction with respect to the static base. The device can also include a flex hinge assembly configured to allow motion of the moving carriage in the Z direction and limit movement in other directions. The flex hinge assembly can include at least two flex hinge structures disposed on corresponding sides of the flex hinge actuator. Each flex hinge structure can include a first link and a second link. The first link can connect to the static base at a first hinge joint and to the second link at a second hinge joint. The second link can connect to the moving carriage at a third hinge joint.

In some instances, the device can further include a bimorph actuator configured to push on the first link of each of the flex hinge structures. The bimorph actuator can include a beam including a first end fixed to the flex hinge structure and a second end comprising a free end, wherein movement of the free end is configured to push on the at least one link. The bimorph actuator can also include a shape metal alloy (SMA) material disposed along the beam between the fixed end and the free end.

In some instances, the flex hinge structure includes at least a first flex hinge structure orientated in a first direction and a second flex hinge structure oriented in a second direction opposite that of the first direction.

In some instances, the device can further include a lens connected to the moving carriage, an outer housing, and four bimorph actuators, with each of the four bimorph actuators being disposed on the outer housing and providing X/Y motion of the moving carriage.

In some instances, the device can further include a cover disposed over a portion of the moving carriage and outer housing, the cover comprising end stops to limit movement of the moving carriage past a threshold stroke range.

In some instances, the device can further include an image sensor assembly disposed below the flex hinge assembly and a flexible sensor circuit connected to the flex hinge assembly and the image sensor assembly.

In another example embodiment, an actuator is provided. The actuator can include a static base, a moving carriage configured to move with respect to the static base and a flex hinge assembly configured to allow motion of the moving carriage in a first direction and limit movement in other directions. The flex hinge assembly can include at four flex hinge structures disposed each side of the flex hinge actuator.

In some instances, each flex hinge assembly includes a first link and a second link, wherein the first link connects to the static base at a first hinge joint and to the second link at a second hinge joint, and wherein the second link connects to the moving carriage at a third hinge joint.

In some instances, the actuator further includes a lens connected to the moving carriage, an outer housing, and four bimorph actuators, with each of the four bimorph actuators being disposed on the outer housing and providing X/Y motion of the moving carriage, and a cover disposed over a portion of the moving carriage and outer housing, the cover comprising end stops to limit movement of the moving carriage past a threshold stroke range.

In some instances, the actuator further includes an outer housing, four bimorph actuators, with each of the four bimorph actuators being disposed on the outer housing and providing X/Y motion of the moving carriage, an image sensor assembly disposed below the flex hinge assembly, and a flexible sensor circuit connected to the flex hinge assembly and the image sensor assembly.

Other features and advantages of embodiments of the present invention will be apparent from the accompanying drawings and from the detailed description that follows.

### BRIEF DESCRIPTION OF THE DRAWINGS

Embodiments of the present invention are illustrated, by way of example and not limitation, in the figures of the accompanying drawings, in which like references indicate similar elements and in which:

FIG. 1 illustrates an example 2-sided flex hinge assembly actuator according to some embodiments.

FIG. 2 illustrates an example 4-sided flex hinge actuator according to some embodiments.

FIGS. 3A-C illustrate various views of an example 2-sided flex hinge actuator with pivot hinges according to some embodiments.

FIGS. 4A-D illustrate views of a 2-sided flex hinge actuator assembly according to some embodiments.

FIGS. 5A-5D illustrate view of an example 4-sided flex hinge actuator assembly according to some embodiments.

FIG. 6 illustrates an example actuator with motion configured to move in a Z direction according to some embodiments.

FIGS. 7A-7B illustrate example views of a flex hinge according to some embodiments.

FIGS. 8A-8B illustrate a flex hinge actuator as part of an autofocus system according to some embodiments.

FIGS. 9A-9B illustrate views of a flex hinge lens shift actuator according to some embodiments.

FIGS. 10A-10B illustrate an example flex hinge sensor shift actuator with both OIS and AF according to some embodiments.

FIGS. 11A-B illustrate a top view and an iso view of an actuator with X/Y motion with Z motion according to some embodiments.

FIG. 12 illustrates an example actuator with W force indicators according to some embodiments.

FIG. 13 is an illustration of an actuator with a representation of forces applied to the actuator according to some embodiments.

FIGS. 14A-B illustrate example actuators with simulated results for input and output according to some embodiments.

FIGS. 15A-C illustrate views of prior art bimorph actuators which may be used with some embodiments described herein.

### DETAILED DESCRIPTION

The present embodiments relate to a flex hinge actuator. The actuator can include a base and a moving carriage configured to move in a direction (e.g., Z direction). A flex hinge assembly can include structures disposed on multiple sides (e.g., 2-sides, 4-sides). The flex hinge assembly structures can limit movement of the moving carriage in other directions than the Z direction to limit adverse motions of the moving carriage. The actuators as described herein can include a simple structure to constrain pitch and yaw tilt during Z motion of a payload. The actuator can push on sides of structure to move a carriage up and down (or in the Z-direction).

In some instances, the flex hinge actuator can include a multi-sided (e.g., 2 or more sided) hinge-link structure (e.g., with three hinges and two links per side of the actuator. A 2-sided flex hinge assembly can include a minimal number of components to control Z direction motion of the payload. Both hinge-link structures can be designed to allow Z motion of a moving carriage while minimizing other degrees of freedom (X, Y, pitch, yaw, roll).

In some instances, some adverse motion can occur while applying forces to move in Z due to unbalanced forces, putting twisting torque and out of plane bending forces on the hinges. The adverse motion can be unwanted motion of the moving carriage in the X, Y translational direction and tilt about all 3 axes of motion. The design of the actuator with hinge stiffness and actuator push location can minimize this adverse motion.

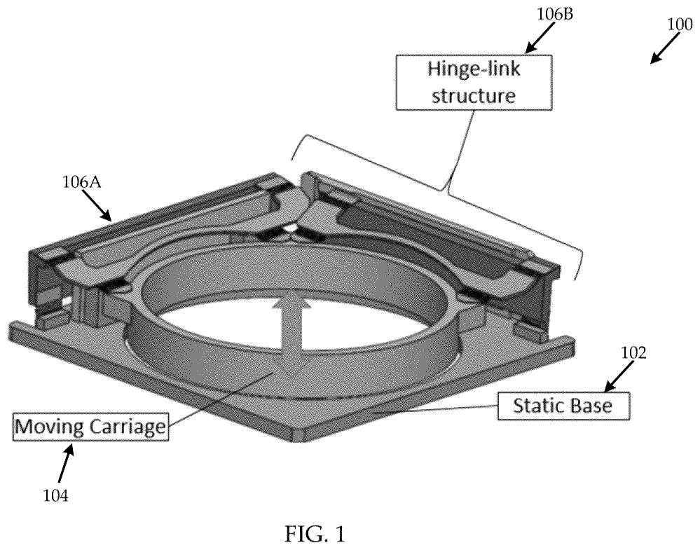

FIG. 1 illustrates an example 2-sided flex hinge assembly actuator 100. As shown in FIG. 1, the actuator 100 can include a static base 102, a moving carriage 104, and a hinge-link structure 106A-B. The moving carriage 104 can be configured to move (in a direction as shown by the arrow in FIG. 1) with respect to the static base 102. Further, the moving carriage 104 can be circular and configured to receive a lens.

The hinge-link structure 106A-B can allow for Z motion of the moving carriage 104 while minimizing movements in any other direction. Each hinge link structure (e.g., 106A-B) can include a lower link connected to the static base 102 and an upper link connecting the base portion to the moving carriage. As described in greater detail below, the hinge link structure 106A-B can include a hinge that allows for movement of the link portion to move and stabilize the moving carriage 104.

Another example design of the flex hinge actuator can include a 4-sided flex hinge assembly. This design flex hinge actuator can be inherently balanced with hinge-link structures on all 4 sides of the actuator. Further, this actuator design can have little to no adverse motion while applying forces to move in the Z direction.

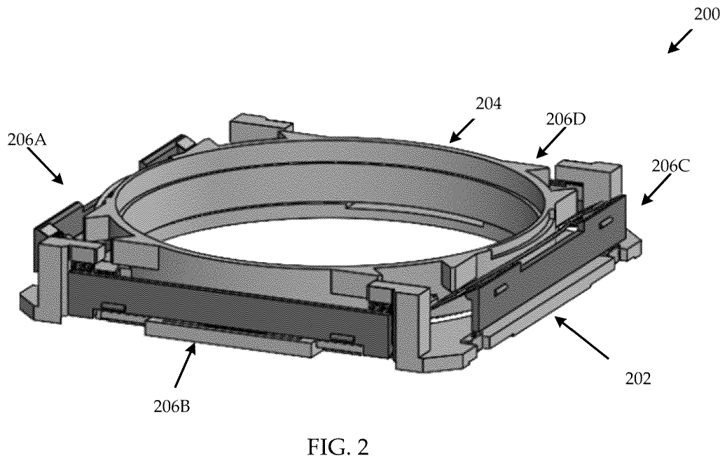

FIG. 2 illustrates an example 4-sided flex hinge actuator 200. As shown in FIG. 2, the actuator 200 can include a static base 202 and moving member 204 can be configured to move with respect to the base 202. The hinge-link assembly 206 can include a 4-sided flex hinge assembly (e.g., flex hinge structures 206A-D) disposed around each of four sides of the actuator 200.

Another example design can include a 2-sided flex hinge actuator design with pivot hinges. The concept can be to weld a wire (e.g., a piano wire) to a stainless steel (SST) portion of the actuator to be the pivot. The mating socket of the actuator can then be injection molded. Input forces at various locations can generate the desired Z stroke motion. The pivot can push on both Link_1 sides or push directly on the moving carriage. Such a design can have an unwanted tilt constrained by the structure.

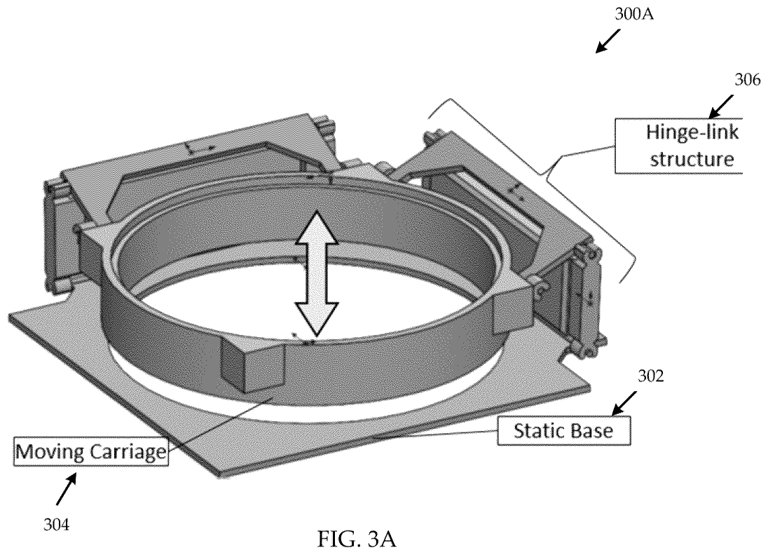

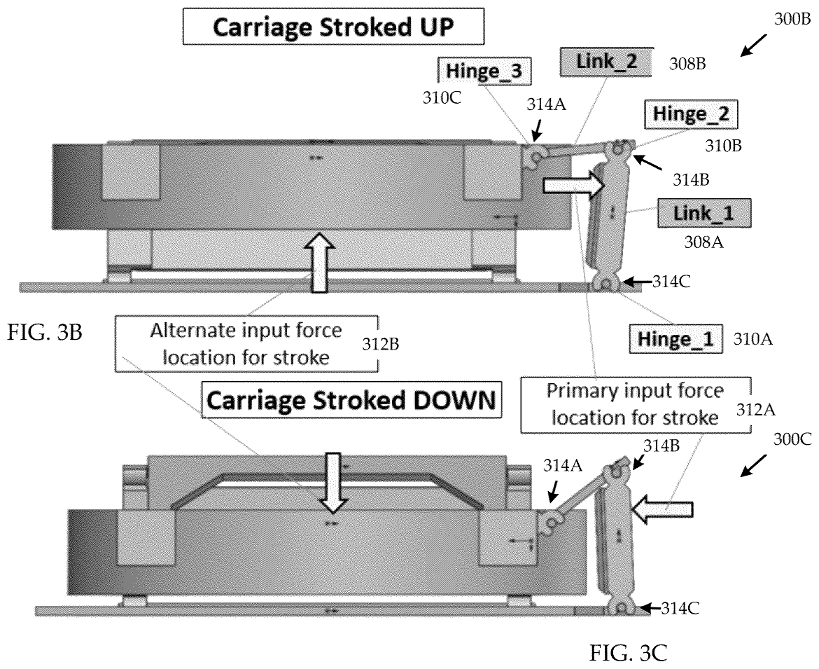

FIGS. 3A-C illustrate various views of an example 2-sided flex hinge actuator 300A-C with pivot hinges. As shown in FIG. 3A, the actuator 300A can include a static base 302, moving carriage 304, and a hinge-link structure 306. The hinge-link structure 306 can include pivot hinges as described herein.

For instance, as shown in FIG. 3B, the actuator 300B can have a hinge-link structure with links 308A-B and hinges 310A-C. The links 308A-B and hinges 310A-C can be in a first position with the moving carriage 304 stroked up. Further, in FIG. 3C, the actuator 300C the links 308A-B and hinges 310A-C can be in a second position with the moving carriage 304 stroked down. A first position 312A can include a primary input force location for stroke and a second position 312B can include an alternative input force location for stroke.

Further, each hinge can be configured to rotate to move the links between various positions via pivots 314A-C. For example, a first pivot 314A can be between moving carriage and link_2 308B. Second pivot 314B can connect link_2 308B to hinge_2 310B. Further, third pivot 314C can be between static base and link_1 308A. A rod can be disposed in each hinge portion to stabilize each hinge and allow for rotation of each pivot that moves the links 308A-B, respectively.

Another example design can include a 2-sided flex hinge actuator assembly. This design can include a thin flexible metal hinge material. The bimorph arms can push on sides of both Link_1 components. This design can have no hinge slop or backlash, along with a good dynamic tilt. The hinge thickness of 20-25 um with an etched pattern can allow for an allowable actuator force for SMA actuators. In some instances, unwanted X/Y and tilt motion can occur while applying forces to move in Z due to unbalanced force with a 2-sided design. In some instances, the flex hinge can be made of steel, nitinol, a high strength copper alloy, or another suitable spring material. The thickness range for the flex hinge can be between 20-25 um, or between 15-30 um.

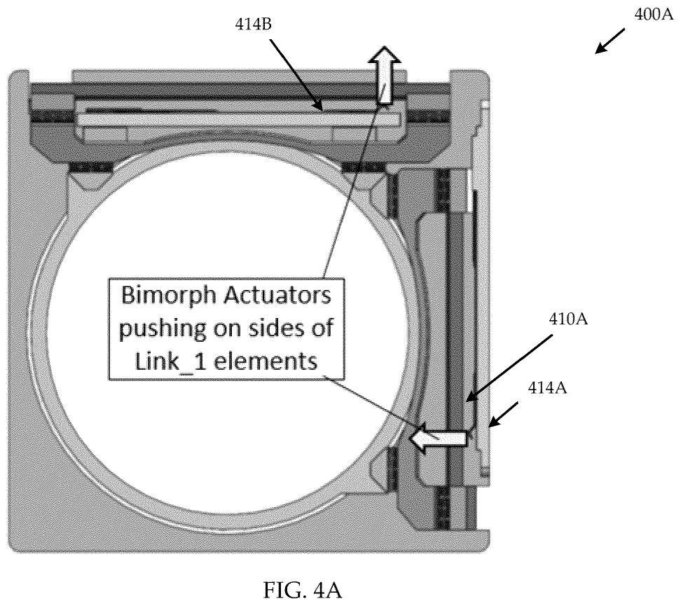

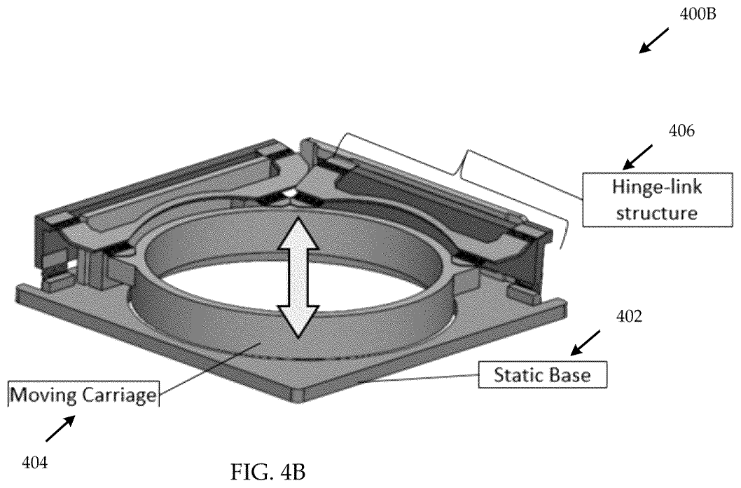

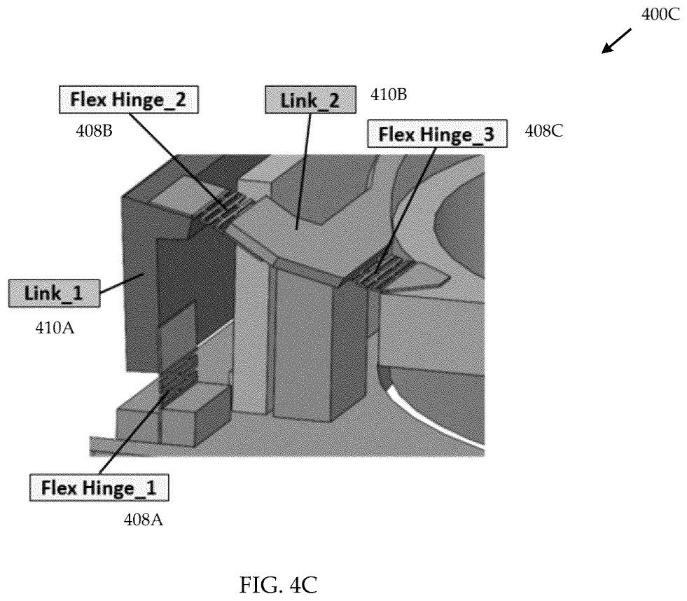

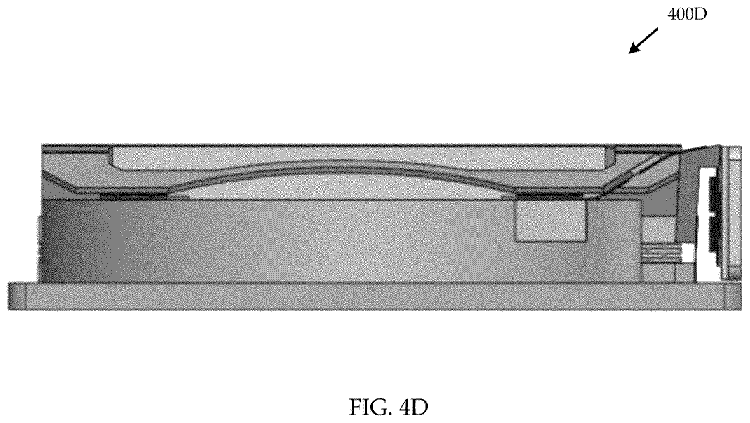

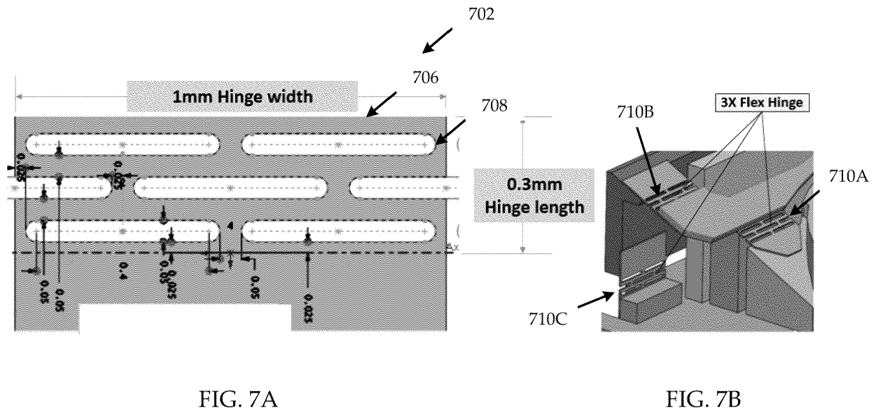

FIGS. 4A-D illustrate views of a 2-sided flex hinge actuator assembly 400A-D. For example, as shown in FIG. 4A, the actuator 400A can include bimorph actuators 414A-B pushing on sides of link_1 elements (e.g., 410A). Further, FIG. 4B illustrates an actuator 400B with a static base 402, moving carriage 404, and a hinge-link structure 406. The hinge-link structure as shown in FIG. 4C can include links 410A-B and flex hinges 408A-C. FIG. 4D is a side view of an actuator 400D as described herein. The flex hinges 408A-C as described in FIG. 4A-D are described in greater detail with respect to FIG. 7.

The flex hinges 408A-C can include a patterned flexible material linking any of the moving carriage and links 410A-B. The flex hinges 408A-C can include spaces between parts of the patterned flex hinge to allow for flexibility of hinges. Further, the link portion can be curved to match or correspond with a curvature of the moving carriage. The link portion can also include two contact points where the link portion contacts the moving carriage. The pattern of the flex hinge is described in greater detail with respect to FIGS. 7A-7B. The pattern can include a set of long narrow slots where each row of slots is staggered relative to the previous row. The purpose of the patterning can be to reduce bending stiffness of the material in only one direction while trying to maintain in plane stiffness and torsional stiffness.

In some instances, the flex hinge can be full thickness, with no slots. The slot pattern can be used to optimize the performance (reduce bending stiffness, but still allow higher lateral and torsional stiffness of the hinge). Partial etching a pattern or region could also achieve the performance of the slot pattern as described herein.

Another example design can include a 4-sided flex hinge actuator assembly. This design can include an inherently balanced structure with little to no unwanted motion. Actuators can apply force inward on 4 sides to produce a Z motion. The design can further include 2 UP and 2 DOWN hinge-link structures. UP and DOWN structures can be located 900 from each other. UP and DOWN component designs can be the same just orientated upside-down from each other.

Flexible hinges may have no backlash or slop leading to precise positioning control. A thin material can be used, such as SST, Nickel and/or Copper alloy, Superelastic Nitinol, for example. In some instances, the hinge area can be etched to reduce bending stiffness. The links can be stiff and can be metal or plastic. The base can be used to mount the flex-hinge structures. Further, the carriage can move in 1-axis and can hold the payload.

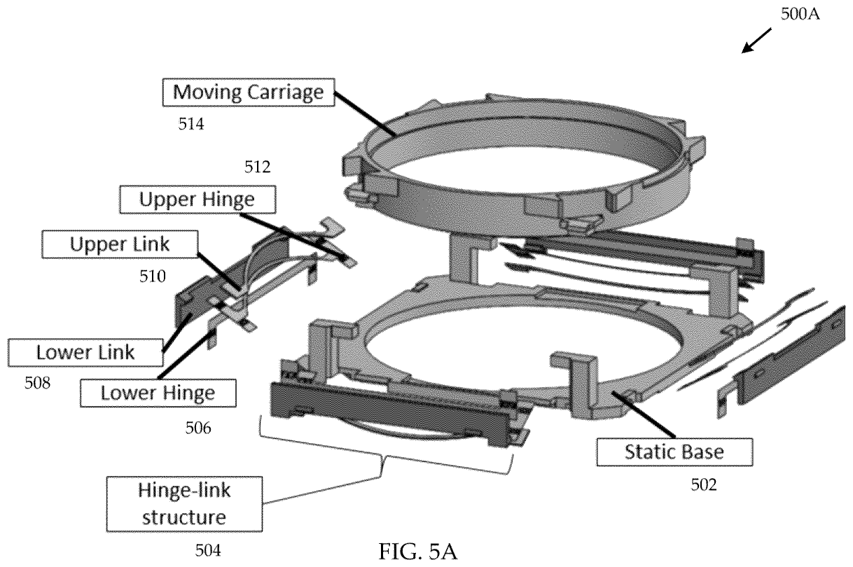

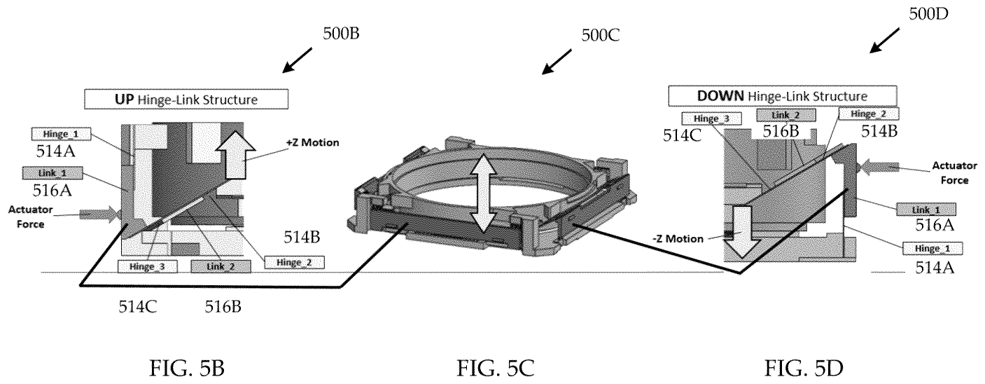

FIGS. 5A-5D illustrate view of an example 4-sided flex hinge actuator assembly 500A-D. As shown in FIG. 5A, an exploded view of the actuator 500A can show a static base 502, hinge-link structure 504, lower hinge 506, lower link 508, upper link 510, upper hinge 512, and moving carriage 514. FIG. 5B illustrates an actuator 500B with the hinge-link structure in an “up” position. As shown in FIG. 5B, a hinge-link structure can include hinges 514A-C and links 516A-B, with the structure configured to move in a positive z direction. FIG. 5C illustrates an actuator 500C configured to move in a z direction. FIG. 5D illustrates an actuator 500D with a hinge-link structure in a “down” position. In FIG. 5D, the hinges 514A-C and links 516A-B can push the actuator in a −Z direction, with an actuator force being applied to link 516A.

The upper hinge 512 can connect the upper link 510 to the moving carriage 514. The upper hinge can include the flex hinge or pivot hinge as described herein. The upper link 510 can connect the moving carriage to the hinge link structure. Further, the lower link 508 can link the static base 502 to the upper link 510.

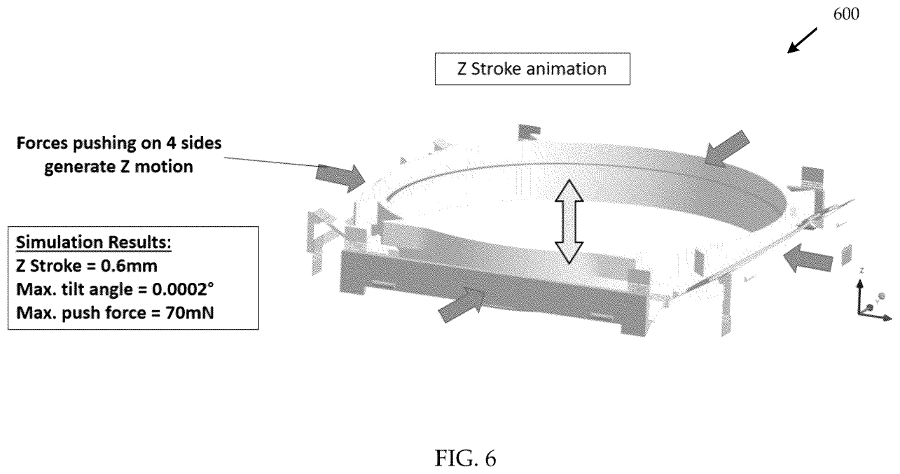

In some instances, a four-sided flex hinge assembly can have coordinated forces generate 1-axis Z motion. FIG. 6 illustrates an example actuator 600 with motion configured to move in a Z direction. Such an actuator can be inherently balanced structure has little to no unwanted tilt or X/Y motion. For instance, forces pushing on 4 sides can generate Z motion.

An example simulation can have a Z-stroke of around 0.6 mm, a maximum tilt angle of around 0.0002 degrees, and a maximum push force of around 70 mN.

In some instances, a flex hinge can have a low bending stiffness and high lateral stiffness. A low bending stiffness can mean a lower force needed to actuate the actuator. A thickness can be between 18 um-25 um for small camera actuators. A material can include any of SST, Cu-alloy, Ni-alloy, and Superelastic Nitinol. A formed/etched in pattern (slots) can help reduce bending stiffness. High lateral stiffness can resist any unwanted tilt motion. A formed in pattern (slots) can allow for wider hinge which increases lateral stiffness. A hinge length can be between 0.1-0.4 mm for small camera actuators. The hinge width can be around 1 mm wide for small camera actuators (adjustable based on stiffness and space requirements).

FIGS. 7A-7B illustrate example views of a flex hinge 702. As shown in FIG. 7A, a flex hinge 702 can include a patterned surface 706 with spaces 708. The spaces 708 can be patterned to include rounded edges and can be disposed along the surface according to a pattern. The flex hinge 702 can have a 1 mm hinge width, and a 0.3 mm hinge length. Further, in FIG. 7B, a flex hinge can include three flex hinges 710A-C.

The slotted pattern in FIG. 7A can reduce bending stiffness of the flexible hinge while maintaining in plane and torsional stiffness. The slots can be longer or shorter and distance between them can be wider or narrower to achieve different stiffness values.

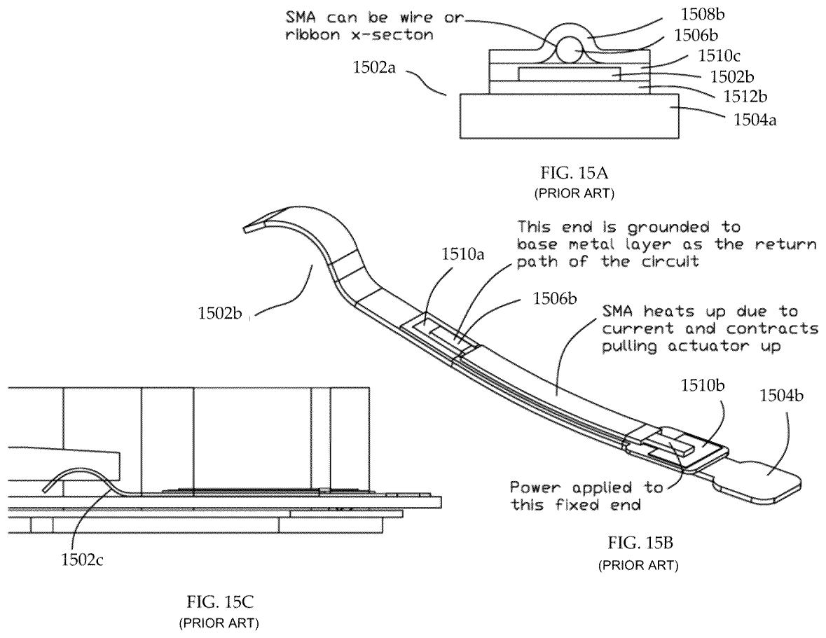

A first application of the flex hinge can include an autofocus system. A 1-axis actuator can be configured to move in the Z-direction. 2-4 Bimorph actuators on the sides of the actuator can push inward. 2 Bimorphs can have a lower number of parts and can be less resource intensive to manufacture. A 4 Bimorph design can have an increased dynamic tilt and stroke performance. Details regarding a bimorph actuator are described in greater detail with respect to FIGS. 15A-C.

A flex hinge assembly can have a difference in opposite axis forces (FX−FY) that can generate Z motion with little to no dynamic tilt. Equal force on sides (FX=FY) can hold the Z position.

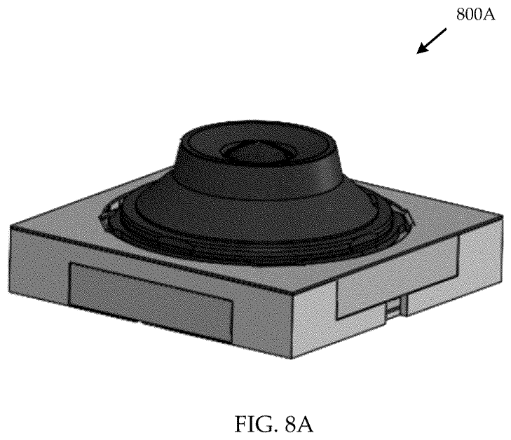

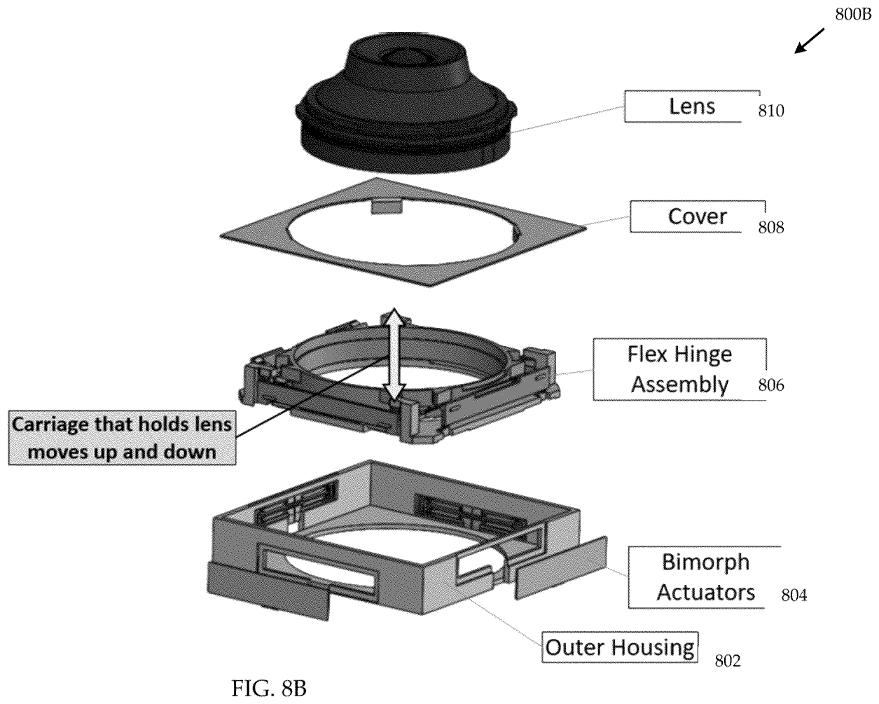

FIGS. 8A-8B illustrate a flex hinge actuator as part of an autofocus system 800A-B. As shown in FIG. 8A, a lens can be disposed above the moving carriage and can be configured to move the lens in the Z direction. In FIG. 8B, the autofocus system can include an outer housing 802, bimorph actuators 804, flex hinge assembly 806, a cover 808, and a lens 810. A carriage can hold the lens and can move up and down in the Z direction.

Another example application can include a flex hinge lens shift system that incorporates both optical image stabilization and autofocus. This can include a 3-axis actuator to move in any of the X/Y/Z directions. The actuator can include a 4 SMA wire total SMA camera actuator. 4 Bimorph actuators on the sides can push inward, which can produce X/Y/Z motion of the lens (OIS+AF).

A flat OIS spring can be used for posture down force and X/Y stroke. The actuator can include slide bearings, and a delta opposing force (same axis) can produce OIS motion.

A flex hinge assembly can include delta opposite axis force on sides (FX−FY) generates Z motion with little to no dynamic tilt. Equal opposite axis force on sides (FX=FY) can hold Z position. A cover can have OIS end stops directly to moving carriage. This can be used to protect the flexible hinges from damage during shock and lens insertion. End stops could also come from the Outer Housing instead of cover (just need to come from a static component).

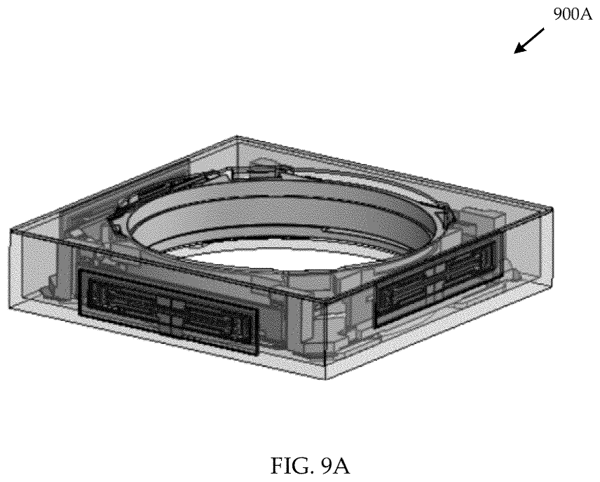

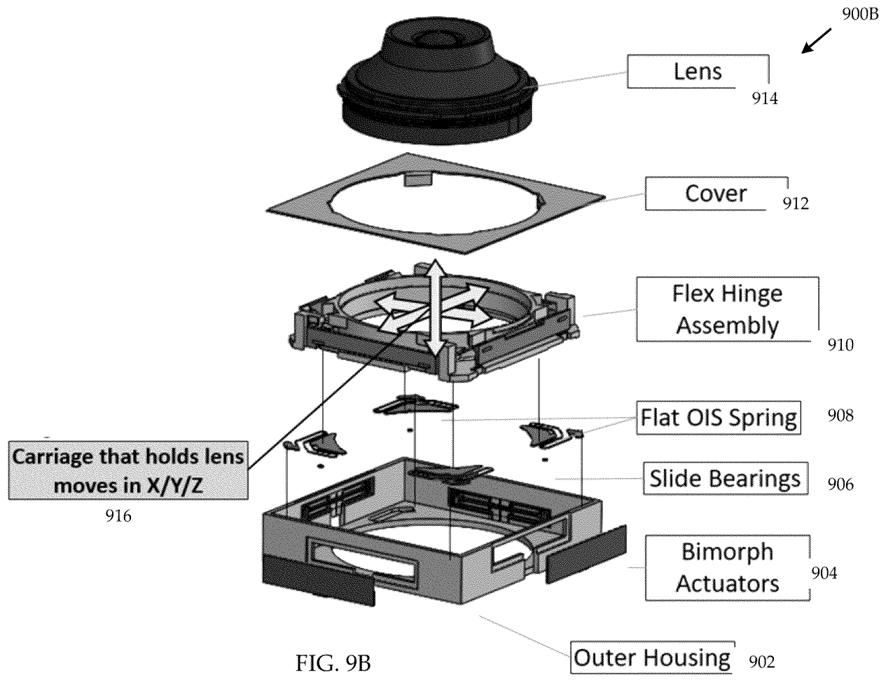

FIGS. 9A-9B illustrate views of a flex hinge lens shift actuator 900A-B. The actuator can include any of an outer housing 902, bimorph actuators 904, slide bearings 906, flat OIS spring 908, flex hinge assembly 910, a cover 912, lens 914, and/or a carriage 916. The carriage can be configured to hold the lens and move in any of the X/Y/Z directions.

Another application of the actuator can include a flex hinge sensor shift actuator with both OIS and AF. This application can include a 3-axis actuator configured to move in any of the X/Y/Z directions. The actuator can include a 4 SMA wire total SMA camera actuator. 4 Bimorph actuators on the sides can push inward, which can produce X/Y/Z motion of the image sensor (OIS+AF).

A flat OIS spring can be used for posture down force and X/Y stroke. Slide bearings can be used, and a delta opposing force (same axis) can produce OIS motion. A flex hinge assembly can be shown hanging upside down from the outer housing with the OIS spring between them, for sensor shift. The image sensor assembly can bond to the moving carriage and moves in X/Y/Z for OIS+AF motion. Flexible sensor circuit can allow for X/Y/Z motion, and the lens can be static.

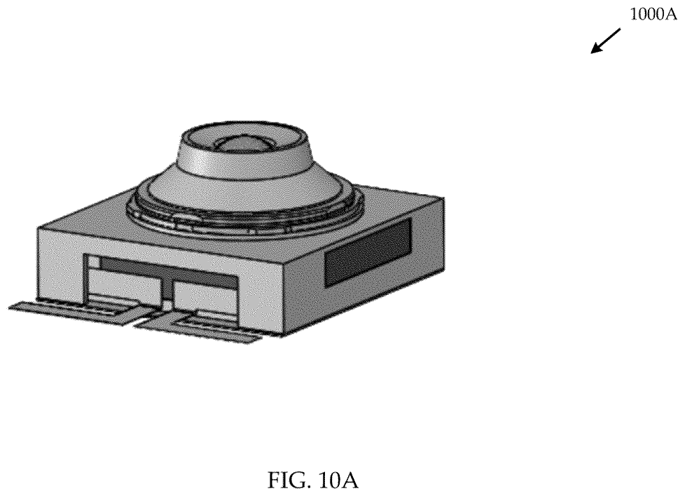

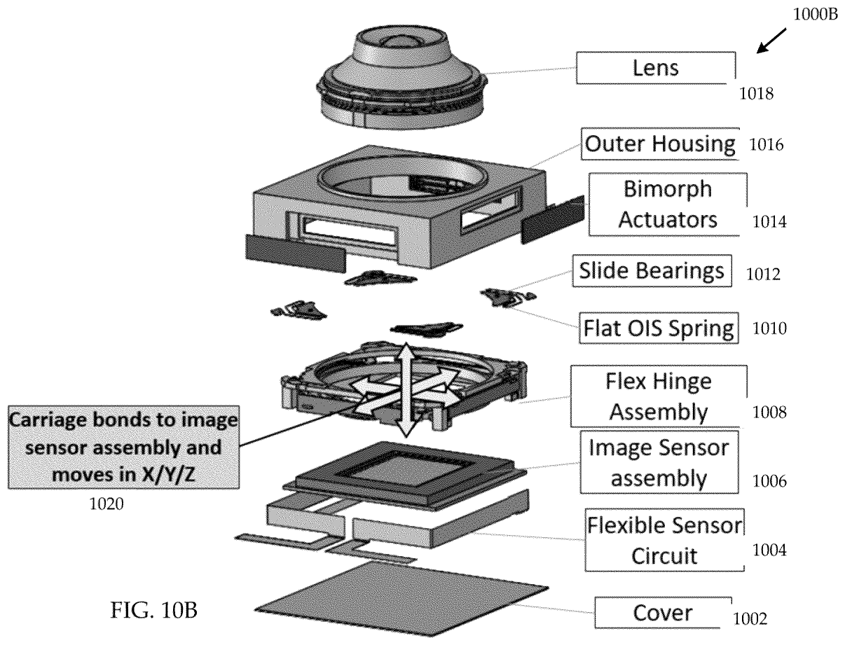

FIGS. 10A-10B illustrate an example flex hinge sensor shift actuator with both OIS and AF. For example, as shown in FIG. 10B, the actuator 1000B can include a cover 1002, a flexible sensor circuit 1004, an image sensor assembly 1006, a flex hinge assembly 1008, a flat OIS spring 1010, slide bearings 1012, bimorph actuators 1014, an outer housing 1016, a lens 1018, and a carriage 1020 that can bond to the image sensor assembly 1006 and can move in the X/Y/Z directions.

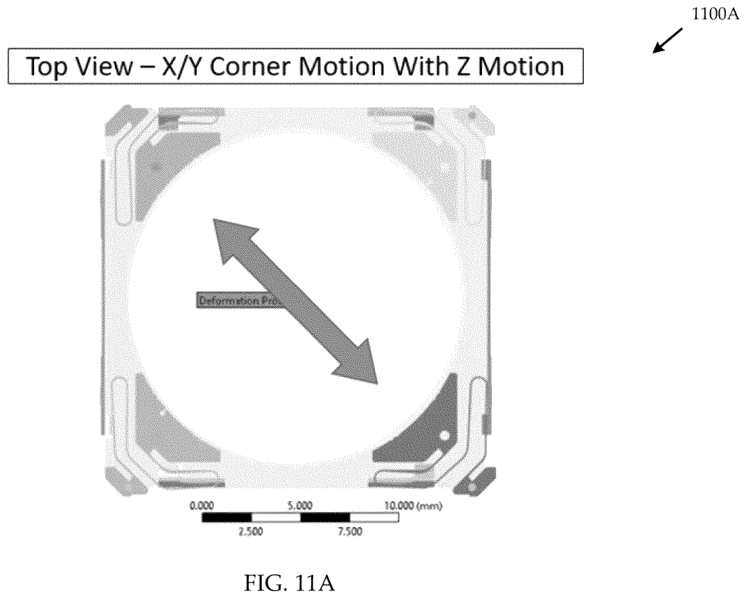

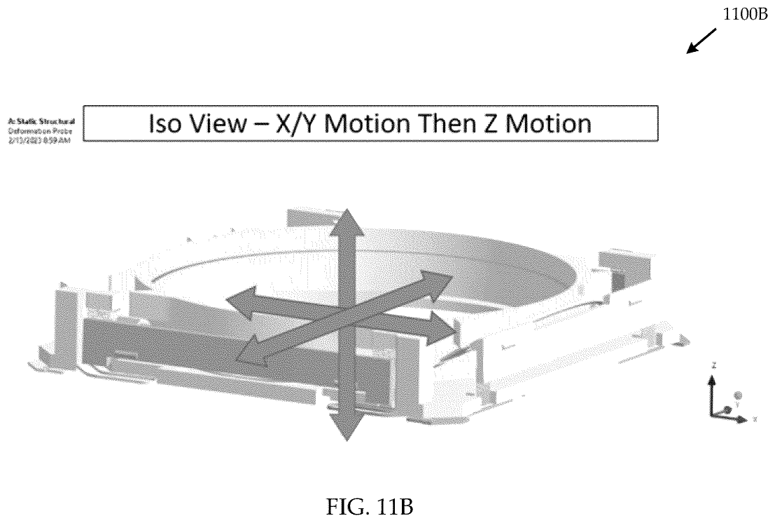

In some instances, a flex hinge lens shift actuator simulation can include various boundary conditions. Such conditions can include forces applied to 4 sides to generate X/Y/Z motion. The forces can simulate output from bimorph actuator, and the force on each side can consider the interaction of OIS and AF motion to achieve the correct X/Y/Z position. FIGS. 11A-B illustrate a top view and an iso view of an actuator 1100A-B with X/Y motion with Z motion.

Various force equations can represent forces used to generate X/Y/Z motion as described herein. A delta force can include a difference between opposing forces which will generate motion in one direction inversely proportional to any structural stiffness in that direction. Example force equations are provided below:

$$\begin{matrix}X\_Delta \_Force = X\_motion * X\_Stiffness = W 2 - W 3 \\ Y\_Delta \_Force = Y\_motion * Y\_Stiffness = W 1 - W 0 \\ Z\_Delta \_Force = Z\_motion * Z\_Stiffness = ( W 1 - W 0 ) - ( W 2 + W 3 )\end{matrix}$$

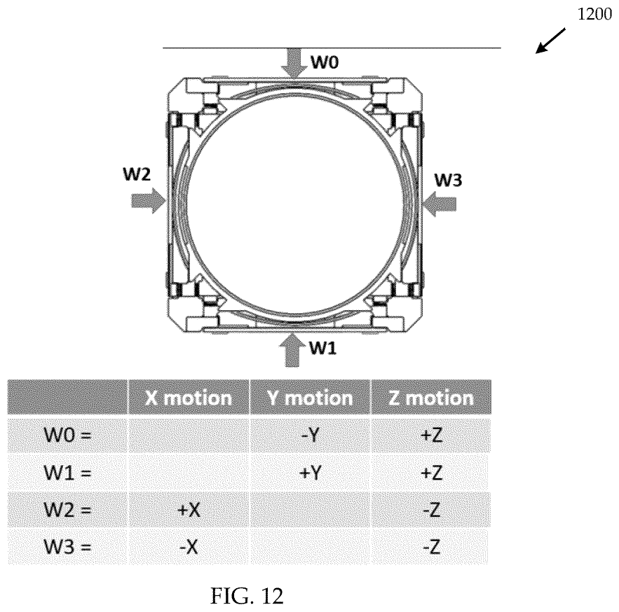

In some instances, transient forces and friction are assumed to be negligible. FIG. 12 illustrates an example actuator 1200 with W force indicators. As shown in FIG. 12, each W force indicator W0-W3 illustrate whether the force provides a positive or negative X/Y/Z motion. The “W” in FIG. 12 can indicate which SMA wire (e.g., wires 0-3) are applying the force.

The total forces can be a summation of OIS forces, AF forces, interaction forces shift AF center, and interaction forces shift AF amplitude.

Equations for a OIS force can include:

$$\begin{matrix}W 0 = - Y\_Delta \_Force \\ W 1 = + Y\_Delta \_Force \\ W 2 = + X\_Delta \_Force \\ W 3 = - X\_Delta \_Force\end{matrix}$$

Equations for AF forces can include:

$$\begin{matrix}W 0 \& W 1 = + Z\_Delta \_Force / 2 \\ W 2 \& W 3 = - Z\_Delta \_Force / 2\end{matrix}$$

Equations for Interaction forces shift AF center can include:

$$\begin{matrix}W 0 \& W 1 = abs ( \pm X\_Delta \_Force ) / 2 \\ W 2 \& W 3 = abs ( \pm Y\_Delta \_Force ) / 2\end{matrix}$$

Equations for Interaction forces shift AF amplitude can include:

$$\begin{matrix}If Z\_motion > 0 : W 0 \& W 1 = - abs ( X\_Delta \_Force / 4 ) - abs ( Y\_Delta \_Force / 4 ) W 2 \& W 3 = 0 \\ If Z\_motion > 0 : W 0 \& W 1 = 0 W 2 \& W 3 = - abs ( X\_Delta \_Force / 4 ) - abs ( Y\_Delta \_Force / 4 )\end{matrix}$$

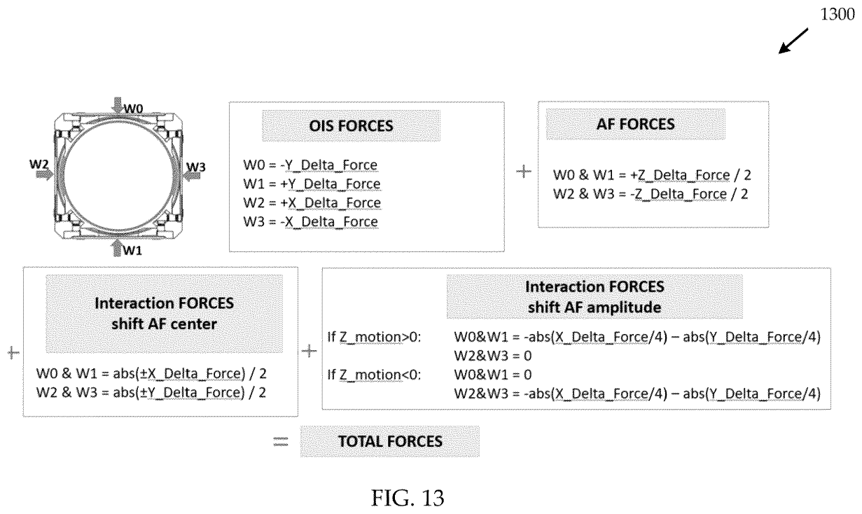

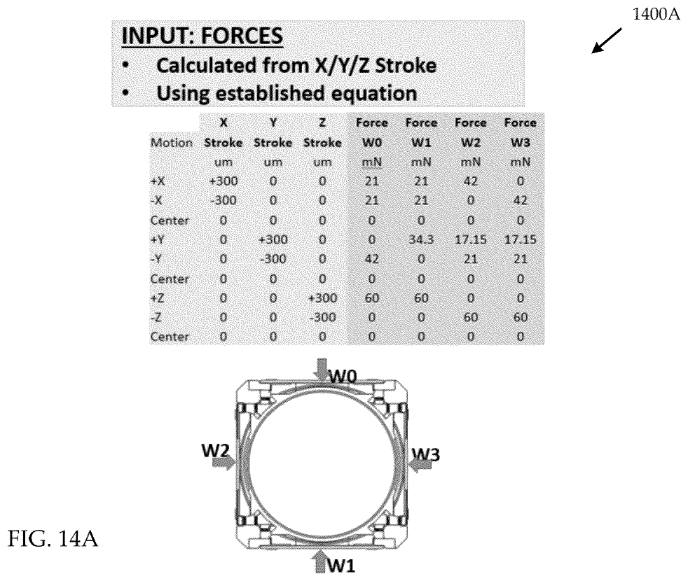

FIG. 13 is an illustration of an actuator with a representation of forces applied to the actuator 1300. As shown in FIG. 13, various forces can be applied to the actuator.

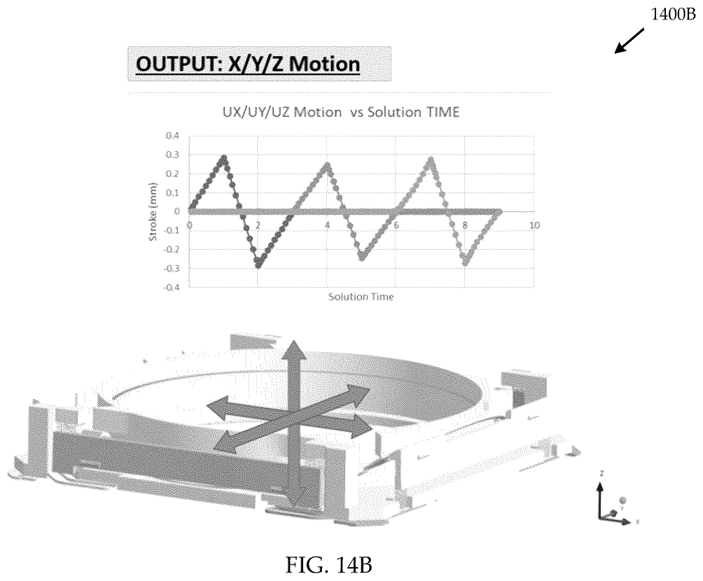

In some instances, input forces can be calculated from X/Y/Z stroke, and an output can include X/Y/Z motion. FIGS. 14A-B illustrate example actuators 1400A-B with simulated results for input and output. For example, FIG. 14A illustrates a table with stroke and forces for each of several motion directions. Further, FIG. 14B can illustrate a graph of stroke vs a solution time.

As noted above, a bimorph actuator can be used as part of a flex hinge actuator. FIGS. 15A-C illustrates views of prior art bimorph actuators which may be used with some embodiments described herein. According to various embodiments, a bimorph actuator 1502 includes a beam 1504 and one or more SMA materials 1506 such as an SMA ribbon 1506 b (e.g., as illustrated in a perspective view of a bimorph actuator including an SMA ribbon according to the embodiment of FIG. 15B) or SMA wire 1506 a (e.g., as illustrated in a cross-section of a bimorph actuator including an SMA wire according to the embodiment of FIG. 15A). The SMA material 1506 is affixed to the beam 1504 using techniques including those describe herein. According to some embodiments, the SMA material 1506 is affixed to a beam 1504 using adhesive film material 1508. Ends of the SMA material 1506, for various embodiments, are electrically and mechanically coupled with contacts 1510 configured to supply current to the SMA material 1506 using techniques including those known in the art. The contacts 1510 (e.g., as illustrated in FIGS. 15A and 15B), according to various embodiments, are gold plated copper pads.

According to embodiments, a bimorph actuator 1502 having a length of approximately 1 millimeter are configured to generate a large stroke and push forces of 50 millinewtons (“mN”) is used as part of a lens assembly, for example as illustrated in FIG. 15C. According to some embodiments, the use of a bimorph actuator 1502 having a length greater than 1 millimeter will generate more stroke but less force that that having a length of 1 millimeter. For an embodiment, a bimorph actuator 1502 includes a 20 micrometer thick SMA material 1506, a 20 micrometer thick insulator 1512, such as a polyimide insulator, and a 30 micrometer thick stainless steel beam 1504 or base metal. Various embodiments include a second insulator 1514 disposed between a contact layer including the contacts 1510 and the SMA material 1506. The second insulator 1514 is configured, according to some embodiments, to insulate the SMA material 1506 from portions of the contact layer not used as the contacts 1510. For some embodiments, the second insulator 1514 is a covercoat layer, such a polyimide insulator. One skilled in the art would understand that other dimensions and materials could be used to meet desired design characteristics.

In a first example embodiment, a flex hinge actuator is provided. The flex hinge actuator can include a static base (e.g., 102) and a moving carriage (e.g., 104) configured to move in a Z direction with respect to the static base. The flex hinge actuator can also include a flex hinge assembly (e.g., 106) configured to allow motion of the moving carriage in the Z direction and limit movement in other directions. The flex hinge assembly can include at least two flex hinge structures (e.g., structures in FIG. 1) disposed on corresponding sides of the flex hinge actuator.

In some instances, the flex hinge assembly includes flex hinge structures disposed each of four sides of the flex hinge actuator (e.g., as shown in FIG. 2).

In some instances, each flex hinge structure includes a first link (e.g., 308A) and a second link (e.g., 308B). The first link can connect to the static base at a first hinge joint (e.g., 310A) and to the second link at a second hinge joint (e.g., 310B). The second link can connect to the moving carriage at a third hinge joint (e.g., 310C). In some instances, any of the first, second, or third hinge joints include a flexible metal hinge (e.g., in FIG. 4C).

In some instances, each flex hinge structure further includes at least one link connecting the moving carriage to the flex hinge structure and a bimorph actuator configured to push on the at least one link. The bimorph actuator can include a beam including a first end fixed to the flex hinge structure and a second end comprising a free end. Movement of the free end can be configured to push on the at least one link. In some instances, the bimorph actuator further includes a shape metal alloy (SMA) material disposed along the beam between the fixed end and the free end.

In some instances, the flex hinge structure includes at least a first flex hinge structure orientated in a first direction and a second flex hinge structure oriented in a second direction opposite that of the first direction.

In some instances, the flex hinge actuator further comprises a lens connected to the moving carriage, an outer housing, and four bimorph actuators, with each of the four bimorph actuators being disposed on the outer housing and providing X/Y motion of the moving carriage.

In some instances, the flex hinge actuator further comprises a cover disposed over a portion of the moving carriage and outer housing, the cover comprising end stops to limit movement of the moving carriage past a threshold stroke range.

In some instances, the flex hinge actuator further comprises an image sensor assembly disposed below the flex hinge assembly and a flexible sensor circuit connected to the flex hinge assembly and the image sensor assembly.

In another example embodiment, a device is provided. The device can include a static base and a moving carriage configured to move in a Z direction with respect to the static base. The device can also include a flex hinge assembly configured to allow motion of the moving carriage in the Z direction and limit movement in other directions. The flex hinge assembly can include at least two flex hinge structures disposed on corresponding sides of the flex hinge actuator. Each flex hinge structure can include a first link and a second link. The first link can connect to the static base at a first hinge joint and to the second link at a second hinge joint. The second link can connect to the moving carriage at a third hinge joint.

In some instances, the device can further include a bimorph actuator configured to push on the first link of each of the flex hinge structures. The bimorph actuator can include a beam including a first end fixed to the flex hinge structure and a second end comprising a free end, wherein movement of the free end is configured to push on the at least one link. The bimorph actuator can also include a shape metal alloy (SMA) material disposed along the beam between the fixed end and the free end.

In some instances, the flex hinge structure includes at least a first flex hinge structure orientated in a first direction and a second flex hinge structure oriented in a second direction opposite that of the first direction.

In some instances, the device can further include a lens connected to the moving carriage, an outer housing, and four bimorph actuators, with each of the four bimorph actuators being disposed on the outer housing and providing X/Y motion of the moving carriage.

In some instances, the device can further include a cover disposed over a portion of the moving carriage and outer housing, the cover comprising end stops to limit movement of the moving carriage past a threshold stroke range.

In some instances, the device can further include an image sensor assembly disposed below the flex hinge assembly and a flexible sensor circuit connected to the flex hinge assembly and the image sensor assembly.

In another example embodiment, an actuator is provided. The actuator can include a static base, a moving carriage configured to move with respect to the static base and a flex hinge assembly configured to allow motion of the moving carriage in a first direction and limit movement in other directions. The flex hinge assembly can include at four flex hinge structures disposed each side of the flex hinge actuator.

In some instances, each flex hinge assembly includes a first link and a second link, wherein the first link connects to the static base at a first hinge joint and to the second link at a second hinge joint, and wherein the second link connects to the moving carriage at a third hinge joint.

In some instances, the actuator further includes a lens connected to the moving carriage, an outer housing, and four bimorph actuators, with each of the four bimorph actuators being disposed on the outer housing and providing X/Y motion of the moving carriage, and a cover disposed over a portion of the moving carriage and outer housing, the cover comprising end stops to limit movement of the moving carriage past a threshold stroke range.

In some instances, the actuator further includes an outer housing, four bimorph actuators, with each of the four bimorph actuators being disposed on the outer housing and providing X/Y motion of the moving carriage, an image sensor assembly disposed below the flex hinge assembly, and a flexible sensor circuit connected to the flex hinge assembly and the image sensor assembly.

According to some embodiments, the processes described herein are used to form one or more of any of mechanical structures and electro-mechanical structures.

Although described in connection with these embodiments, those of skill in the art will recognize that changes can be made in form and detail without departing from the spirit and scope of the invention.

What is claimed is:

1. A flex hinge actuator comprising:
a static base;
a moving carriage configured to move in a Z direction with respect to the static base; and
a flex hinge assembly configured to allow motion of the moving carriage in the Z direction and limit movement in other directions, wherein the flex hinge assembly includes at least two flex hinge structures disposed on corresponding sides of the flex hinge actuator.

2. The flex hinge actuator of claim 1, wherein the flex hinge assembly includes flex hinge structures disposed each of four sides of the flex hinge actuator.

3. The flex hinge actuator of claim 1, wherein each flex hinge structure includes a first link and a second link, wherein the first link connects to the static base at a first hinge joint and to the second link at a second hinge joint, and wherein the second link connects to the moving carriage at a third hinge joint.

4. The flex hinge actuator of claim 3, wherein any of the first, second, or third hinge joints include a flexible metal hinge.

5. The flex hinge actuator of claim 1, wherein each flex hinge structure further includes:
at least one link connecting the moving carriage to the flex hinge structure; and
a bimorph actuator configured to push on the at least one link, wherein the bimorph actuator comprises:
a beam including a first end fixed to the flex hinge structure and a second end comprising a free end, wherein movement of the free end is configured to push on the at least one link.

6. The flex hinge actuator of claim 5, wherein the bimorph actuator further includes a shape metal alloy (SMA) material disposed along the beam between the fixed end and the free end.

7. The flex hinge actuator of claim 1, wherein the flex hinge structure includes at least a first flex hinge structure orientated in a first direction and a second flex hinge structure oriented in a second direction opposite that of the first direction.

8. The flex hinge actuator of claim 1, further comprising:
a lens connected to the moving carriage;
an outer housing; and
four bimorph actuators, with each of the four bimorph actuators being disposed on the outer housing and providing X/Y motion of the moving carriage.

9. The flex hinge actuator of claim 8, further comprising:
a cover disposed over a portion of the moving carriage and outer housing, the cover comprising end stops to limit movement of the moving carriage past a threshold stroke range.

10. The flex hinge actuator of claim 8, further comprising:
an image sensor assembly disposed below the flex hinge assembly; and
a flexible sensor circuit connected to the flex hinge assembly and the image sensor assembly.

11. A device comprising:
a static base;
a moving carriage configured to move in a Z direction with respect to the static base; and
a flex hinge assembly configured to allow motion of the moving carriage in the Z direction and limit movement in other directions, wherein the flex hinge assembly includes at least two flex hinge structures disposed on corresponding sides of the flex hinge actuator, wherein each flex hinge structure includes a first link and a second link, wherein the first link connects to the static base at a first hinge joint and to the second link at a second hinge joint, and wherein the second link connects to the moving carriage at a third hinge joint.

12. The device of claim 11, further comprising:
a bimorph actuator configured to push on the first link of each of the flex hinge structures, wherein the bimorph actuator comprises:
a beam including a first end fixed to the flex hinge structure and a second end comprising a free end, wherein movement of the free end is configured to push on the at least one link; and
a shape metal alloy (SMA) material disposed along the beam between the fixed end and the free end.

13. The device of claim 11, wherein the flex hinge structure includes at least a first flex hinge structure orientated in a first direction and a second flex hinge structure oriented in a second direction opposite that of the first direction.

14. The device of claim 11, further comprising:
a lens connected to the moving carriage;
an outer housing; and
four bimorph actuators, with each of the four bimorph actuators being disposed on the outer housing and providing X/Y motion of the moving carriage.

15. The device of claim 14, further comprising:
a cover disposed over a portion of the moving carriage and outer housing, the cover comprising end stops to limit movement of the moving carriage past a threshold stroke range.

16. The device of claim 14, further comprising:
an image sensor assembly disposed below the flex hinge assembly; and
a flexible sensor circuit connected to the flex hinge assembly and the image sensor assembly.

17. The device of claim 11, further comprising:
a slide bearing and a spring connected to the moving carriage and static base to allow X/Y motion of the moving carriage with Z motion.

18. An actuator comprising:
a static base;
a moving carriage configured to move with respect to the static base; and
a flex hinge assembly configured to allow motion of the moving carriage in a first direction and limit movement in other directions, wherein the flex hinge assembly includes at four flex hinge structures disposed each side of the flex hinge actuator.

19. The actuator of claim 18, wherein each flex hinge assembly includes a first link and a second link, wherein the first link connects to the static base at a first hinge joint and to the second link at a second hinge joint, and wherein the second link connects to the moving carriage at a third hinge joint.

20. The actuator of claim 18, further comprising:
a lens connected to the moving carriage;
an outer housing;
four bimorph actuators, with each of the four bimorph actuators being disposed on the outer housing and providing X/Y motion of the moving carriage; and
a cover disposed over a portion of the moving carriage and outer housing, the cover comprising end stops to limit movement of the moving carriage past a threshold stroke range.
